(19) United States
(12) Patent Application Publication
(10) Pub. No.: US 2016/0117465 A1
(43) Pub. Date: Apr. 28, 2016

(54) METHOD AND APPARATUS FOR CALCULATING AN OVERALL HEALTH QUALITY INDEX AND PROVIDING A HEALTH UPSIDE OPTIMIZING RECOMMENDATION

(71) Applicant: Xerox Corporation, Norwalk, CT (US)

(72) Inventors: ARVIND AGARWAL, Rochester, NY (US); Ion Ho, Rochester, NY (US); Shanmuga-nathan Gnanasambandam, Victor, NY (US)

(21) Appl. No.: 14/520,942

(22) Filed: Oct. 22, 2014

(51) Int. Cl. G06F 19/00

(52) U.S. Cl. CPC G06F 19/3431; G06F 19/322; G06F 19/3443; G06F 19/3481; G06F 19/345

(57) ABSTRACT

A method, non-transitory computer readable medium, and apparatus for method for calculating an overall health quality index (HQI) and providing a health upside optimizing recommendation are disclosed. For example, the method collects data associated with an individual from an external data source, filters the data to identify a plurality of features, divides each one of the plurality of features into one or more of six action classes, builds one or more models for each one of the six action classes, computes the overall HQI using the one or more models that are built for each one of the six action classes, identifies the health upside optimizing recommendation based on one or more important actionable features selected from the plurality of features and provides the overall HQI and the health upside optimizing recommendation to the individual.

The present disclosure relates generally to quantifying a health status of an individual and, more particularly, to a method and apparatus for calculating a health quality score and providing a health upside optimizing recommendation.

### BACKGROUND

Health assessments and related indices have in the past been computed based on evidence based guidelines and the results of clinical tests. These are either principally clinical only or rule-driven approaches, which are not universally applicable in different sub-populations of people. Further, these approaches neglect other features that could go into assessing health risk.

Health risk assessments can benefit by taking into account the patients' or care-receivers' psyche and related factors. Coupled with clinical data, these non-clinical aspects can provide a more holistic picture of an individual's health.

### SUMMARY

According to aspects illustrated herein, there are provided a method, a non-transitory computer readable medium, and an apparatus for calculating an overall health quality index (HQI) and providing a health upside optimizing recommendation. One disclosed feature of the embodiments is a method that collects data associated with an individual from an external data source, filters the data to identify a plurality of features, divides each one of the plurality of features into one or more of six action classes, builds one or more models for each one of the six action classes, computes the overall HQI using the one or more models that are built for each one of the six action classes, identifies the health upside optimizing recommendation based on one or more important actionable features selected from the plurality of features and provides the overall HQI and the health upside optimizing recommendation to the individual.

Another disclosed feature of the embodiments is a non-transitory computer-readable medium having stored thereon a plurality of instructions, the plurality of instructions including instructions which, when executed by a processor, cause the processor to perform an operation that collects data associated with an individual from an external data source, filters the data to identify a plurality of features, divides each one of the plurality of features into one or more of six action classes, builds one or more models for each one of the six action classes, computes the overall HQI using the one or more models that are built for each one of the six action classes, identifies the health upside optimizing recommendation based on one or more important actionable features selected from the plurality of features and provides the overall HQI and the health upside optimizing recommendation to the individual.

Another disclosed feature of the embodiments is an apparatus comprising a processor and a computer readable medium storing a plurality of instructions which, when executed by the processor, cause the processor to perform an operation that collects data associated with an individual from an external data source, filters the data to identify a plurality of features, divides each one of the plurality of features into one or more of six action classes, builds one or more models for each one of the six action classes, computes the overall HQI using the one or more models that are built for each one of the six action classes, identifies the health upside optimizing recommendation based on one or more important actionable features selected from the plurality of features and provides the overall HQI and the health upside optimizing recommendation to the individual.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of a system of the present disclosure;

FIG. 2 illustrates an HQI computation table of the present disclosure;

FIG. 3 illustrates an example graphical user interface (GUI) screen of the present disclosure;

FIG. 4 illustrates another example GUI screen of the present disclosure;

FIG. 5 illustrates an example flowchart of one embodiment of a method for calculating an overall health quality index (HQI) and providing a health upside optimizing recommendation; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for calculating an overall health quality index (HQI) and providing a health upside optimizing recommendation. As discussed above, health assessments and related indices have in the past been computed based on evidence based guidelines and the results of clinical tests. These are either principally clinical only or rule-driven approaches, which are not universally applicable in different sub-populations of people. Further, these approaches neglect other features that could go into assessing health risk.

Embodiments of the present disclosure provide a novel method for computing an objective health quality index (HQI) that is data driven. The present disclosure also provides recommendations for potential upside to improve the HQI over time. The embodiments of the present disclosure use a labeled test data set as its fundamental basis and add to it an individual's own actions and behaviors over time. The features in the combined data set include both clinical and non-clinical features. The embodiments of the present disclosure simultaneously factor the individual's own view of personal health and an expert body's view of the same person's health and train a suite of models.

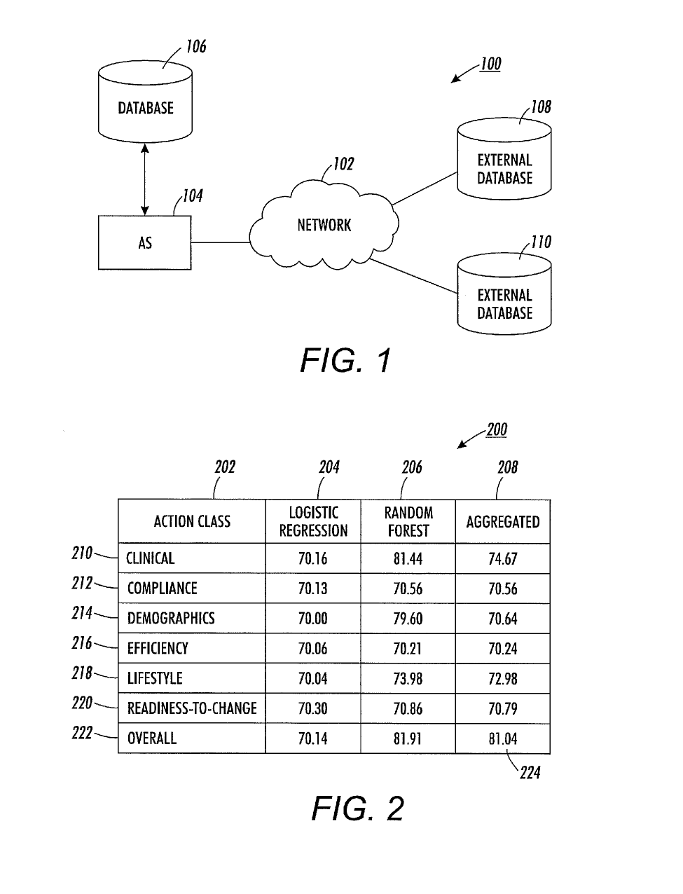

FIG. 1 illustrates an example system 100 of the present disclosure. In one embodiment, the system 100 includes a communications network 102, an application server (AS) 104, a database (DB) 106 and one or more external databases 108 and 110. In one embodiment, the communications network 102 may be any type of communications network including, for example, an Internet Protocol (IP) network, a cellular network, a broadband network, and the like.

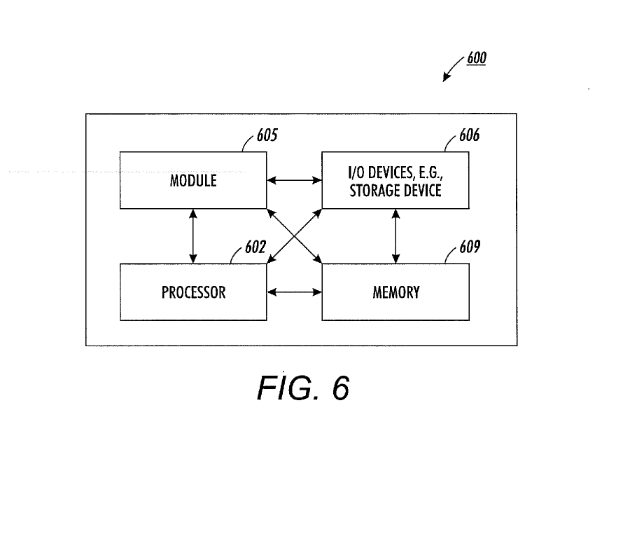

In one embodiment, the AS 104 may be in communication with the communications network 102 over a wireless or wired connection. In one embodiment, the AS 104 may be deployed as a general purpose computer as described below with reference to FIG. 6. The AS 104 may perform the functions and the methods described herein.

In one embodiment, the AS 104 may collect data from one or more external databases 108 and 110. Although only two external databases 108 and 110 are illustrated in FIG. 1, it should be noted that any number of external databases may be deployed. The external databases 108 and 110 may be any database that is not controlled by the same entity, company or service provider that controls the AS 104 and the DB 106.

In one embodiment the external databases 108 and 110 may be clinical based data and non-clinical based data. For example, the external databases 108 and 110 may be data from the Center for Disease Control (CDC), a medical records database, a health insurance claims database, a prescription database, a lab results database, a clinical visits records database, a health plan enrollment application database, a survey database, and the like.

In one embodiment, the external data may be collected as input data and testing data for building one or more models that are used to compute the HQI. For example, a plurality of features may be extracted from the external data. The features may be anything that may affect a health of the individual that can be quantified from the external data. For example, features may include demographic information such as sex, address, age group, and the like. The features may include health related information such as weight, height, cholesterol levels, blood counts, blood sugar level, and the like. The features may include lifestyle data from surveys such as how often an individual gets a physical exam, how often the individual goes to a doctor's office, how often the individual exercises, a type of diet, and the like.

In one embodiment, each one of the plurality of features may be divided into one or more of six action classes. For example, a single feature may be placed into two or more of the action classes. In other words, each one of the plurality of features is not necessarily limited to a single action class. In one embodiment, the six action classes may include a clinical action class, a compliance action class, a demographics action class, an efficiency action class, a lifestyle action class and a readiness-to-change action class.

In one embodiment, the clinical action class may represent an assessment of health based on the individual's clinical attributes. These attributes may include any clinical test either performed explicitly or diseases that are diagnosable using a clinical test.

In one embodiment, the compliance action class may represent how an individual complies with medical guidelines and adhere to a treatment. For example, complying with guidelines and following a prescribed treatment has an important role to play in determining an individual's health.

In one embodiment, the demographics action class may contain information about a user's demography. For example, the demographics action class may contain information about where the person lives, raises his or her family, an occupation, and the like. Information about environmental and familial conditions may also affect the health of the individual and those factors are taken into account for computing the HQI.

In one embodiment, the efficiency action class may relate to whether the individual will utilize cost-effective, regular and preventive mechanisms as opposed to “last minute” efforts. One example of the efficiency action class may contain information relating to an individual going to a primary care physician versus using the emergency room. Another example may be taking flu shots on time as a preventive measure.

In one embodiment, the lifestyle action class may relate to a variety of features directly in the control of the individual. Examples of lifestyle features may include exercise, smoking, drinking, resting, eating habits or diet, and the like.

In one embodiment, the readiness-to-change action class may relate to whether the individual will progress through stages of change. For example, the readiness-to-change action class may track if the individual exercises or readily adopts defined measures in a set of regular visits to a doctor's office or health clinic.

The plurality of features that are divided into the six action classes may be stored in the DB 106. From the plurality of features, one or more actionable features may also be identified based on domain knowledge accumulated from the training data and testing data that are compiled from the data collected from the various external databases 108 and 110. For example, over time certain features may be known to be actionable features.

In one embodiment, actionable features may be defined as features which an individual may control. For example, actionable features may include weight (e.g., the individual may diet to regulate his or her weight), smoking, drinking, blood sugar level (e.g., the individual may control his or her sugar intake), regular physicals, and the like. Some features may not be actionable, such as for example, genetic or hereditary dispositions such as having a fatty liver, high blood pressure, allergies to certain foods that may affect the individual's diet, a handicap that prevents the individual from taking regular visits to a doctor's office, and the like. In one embodiment, the plurality of features that are identified as actionable features may be stored in the DB 106.

As noted above, once the features are divided into one or more of the action classes, one or more models may be built for each one of the six action classes based on the features that are included in each respective action class. In one embodiment, each action class may have the same one or more models. In another embodiment, each action class may have different ones of the one or more models.

The one or more models may then be used to calculate an HQI for each action class. FIG. 2 illustrates one example of a HQI computation table 200. In the example of FIG. 2, each one of the six action classes uses logistic regression models or random forest models. It should be noted that logistic regression and random forest are only example models and other models may be used. For example, if training data has binary labels then any model which is capable of performing binary classification can be used such as support vector machines, decision trees, ensembles methods, neural networks, and the like. On the other hand, if training data labels are real values instead of binary labels, any model that is capable for performing regression tasks, can be used. Examples of such models are decision tree, linear regression, ridge regression, support vector regression, and the like.

Any of the models may be combined with rules that a physician or subject matter expert may outline. For example, physicians may consider certain values or ranges of health factors to be outside the limits of what they would consider healthy. If a multitude of rules hold true, the effect of the rules may be combined using additive methods, multiplicative methods, aggregation methods or other suitable means. In this way, computation of scores for certain variables may get rerouted to a rules bank that either combine machine-learning methods and physician-determined rules or use standalone rules. This may add human factors to variables that may be considered exceptions.

In one embodiment, the HQI computation table 200 may include a column 202 for action classes and include rows 210, 212, 214, 216, 218 and 220 for each one of the six action classes. In one embodiment, a column 204 may be used for HQIs computed using a logistic regression model and a column 206 may be used for HQIs computed using a random forest model. In one embodiment, an aggregated column 208 may be used to aggregate the HQI for each one of the models in columns 204 and 206 for each one of the six classes. In one embodiment, an overall row 222 may be used to compute the overall HQI for each model based on all six classes. The overall HQIs in the row 222 and the aggregated HQIs in column 208 may then be aggregated to compute an overall HQI 224.

In one embodiment, the HQIs may be aggregated using a variety of computational methods. For example, the HQIs may be aggregated using a weighted average, a mean, and the like. In the example in FIG. 2, the aggregated column 208 is calculated by building another model such as logistics regression or random forest on top of the columns 204 and 206. In this example, for each row 210-220, all columns 204 and 206 are considered as features, similar to the features of sex, age, and the like that were features for calculating rows 210-220. For each row, a model such as logistic regression or random forest is built using columns as features, which aggregates these features by providing them appropriate weighing resulting in the aggregated score given by column 208. Besides building a new model, other aggregation methods such as simple averaging can also be used. The overall row 222 for each one of the columns 204, 206 and 208 are calculated by a similar aggregation mechanism. Here all six rows 210-220 act as features. For each column 204 and 206, a new model such as logistic regression or random forest is built on top of six features given by rows 210-220, which aggregate all row features by giving them appropriate weighting resulting in a final score which is in row 222. Besides building a new model, other aggregation methods such as simple averaging can also be used.

In one embodiment, during the computation of the HQIs, one or more important features may be identified from the features in each one of the six classes. In one embodiment, the important features may be defined as those features that create a largest delta in the HQI when the feature is included or excluded from the HQI computation. In other words, the important features may be the features that have the largest effect on the computation of the HQI.

In one embodiment, a top k number of important features may be selected from each one of the six action classes. In other words, dithering is performed on the features from each one of the six action classes to obtain the top k number of important features.

In one embodiment, a health upside optimizing recommendation may then be based on one or more actionable important features selected from the actionable features and the important features. For example, the one or more actionable important features are features that are identified as being important and also identified as being actionable. In other words, even if a feature is important, but not actionable, the feature may not be helpful in being part of the health upside optimizing recommendation as the individual may not have any control over the feature and cannot improve his or her overall HQI based on the feature.

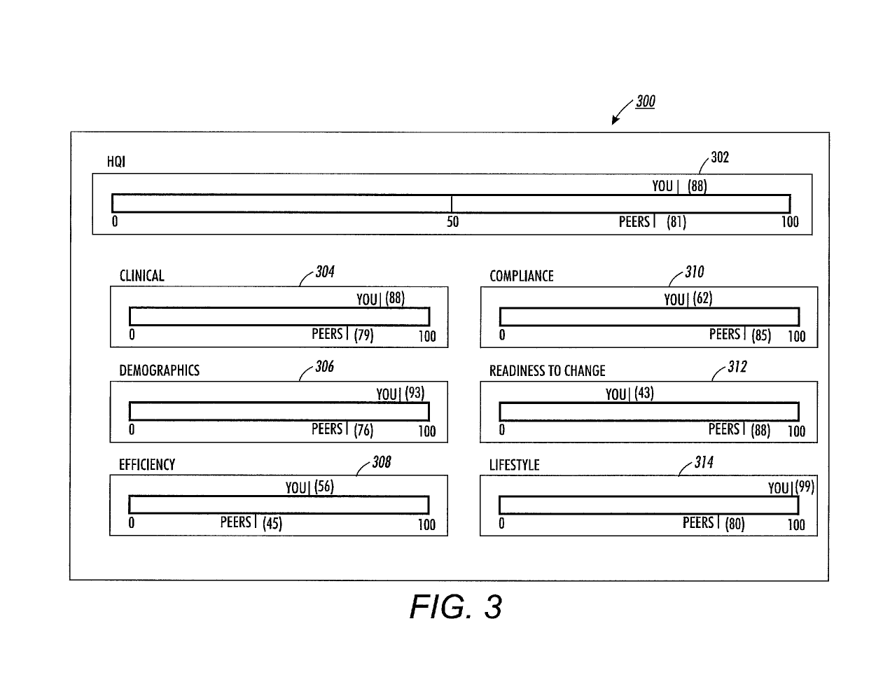

In one embodiment, once the overall HQI is computed and the health upside optimizing recommendation are selected, the overall HQI and the health upside optimizing recommendation may be provided to the individual. In one embodiment, the overall HQI may be presented via a graphical user interface (GUI) 300 illustrated in FIG. 3.

In one embodiment, the GUI 300 may display the overall HQI 302 and the HQI for each one of the six action classes 304, 306, 308, 310, 312 and 314. In one embodiment, the individual's score may be displayed alongside a peer score so that the individual can compare his or her score to his or her peers.

In one embodiment, the peer score may be computed based on an average of a particular group that the individual belongs to. For example, the particular group may be a demographic group (e.g., age, region, and the like). In another embodiment, the particular group may be a group with a common ailment (e.g., diabetics, high blood pressure, and the like).

In one embodiment, the peer score may be computed using the HQIs and the overall HQIs of other individuals that are computed by the AS 104 and stored in the DB 106. For example, each time a new individual computes his or her HQIs and overall HQI, the data may be stored in the DB 106 and used for the peer scores displayed in the GUI 300.

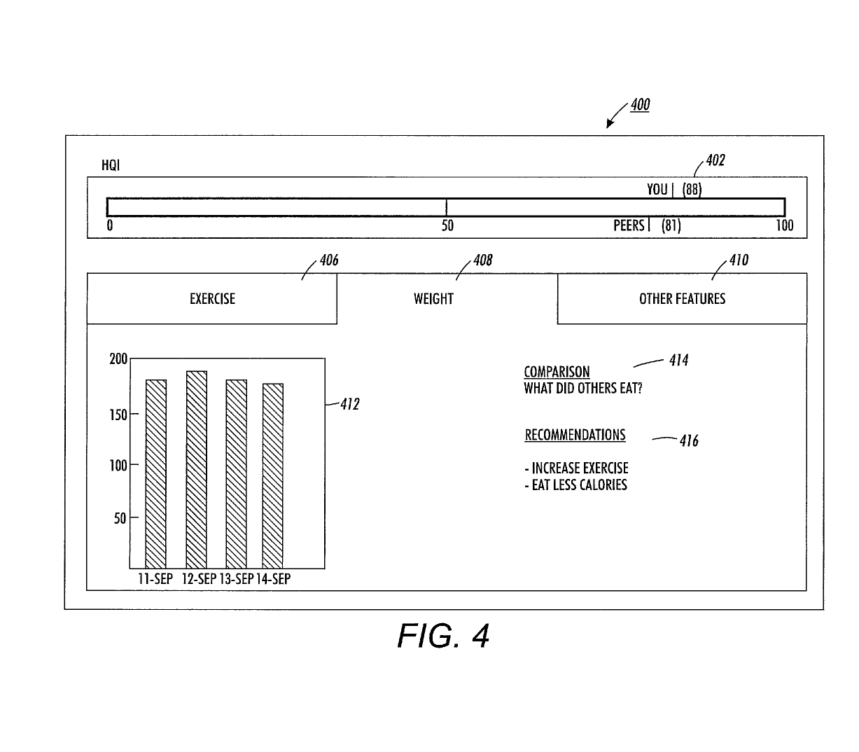

In one embodiment, the health upside optimizing recommendation may be provided to the individual via a GUI 400 illustrated in FIG. 4. In one embodiment, the GUI 400 may also include the HQI 402. The GUI 400 may also include one or more important actionable features 406, 408 and 410. The important actionable features may be presented in separate tabs that provide additional information for the selected important actionable feature. For example, the feature of weight 408 may include a chart 412 of weight over time. A comparison 414 may be provided providing information on what other individuals are eating.

In addition, the health upside optimizing recommendation 416 may be provided. For example, the health upside optimizing recommendation 416 may be to increase exercise and eat fewer calories (e.g., dieting). In other words, if weight was selected as an important actionable feature, then weight may have a significant impact on the individual's overall HQI. Thus, the health upside optimizing recommendation 416 may help to optimize or improve the individual's overall HQI for future calculations.

In one embodiment, the overall HQI may be computed for each individual periodically over a period of time. The overall HQI may be tracked for each individual and graphically presented (e.g., via the GUI 300 or 400). As a result, individuals may be provided with an objective data driven view of his or her overall healthiness and be provided with recommendations on how to improve his or her overall HQI.

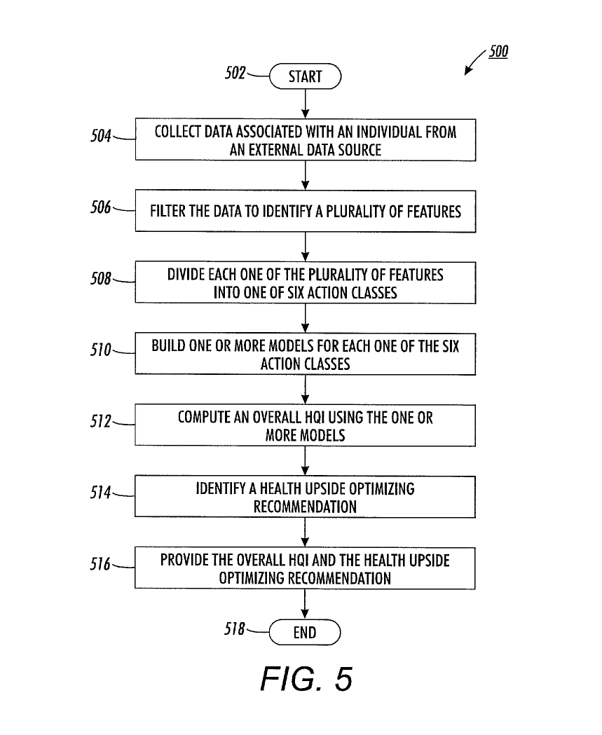

FIG. 5 illustrates a flowchart of a method 500 for calculating an overall health quality index (HQI) and providing a health upside optimizing recommendation. In one embodiment, one or more steps or operations of the method 500 may be performed by the AS 104 or a general-purpose computer as illustrated in FIG. 6 and discussed below.

At step 502 the method 500 begins. At step 504, the method 500 collects data associated with an individual from an external data source. For example, the external data sources may be data from external databases such as the Center for Disease Control (CDC), a medical records database, a health insurance claims database, a prescription database, a lab results database, a clinical visits records database, a health plan enrollment application database, a survey database, and the like.

At step 506, the method 500 filters the data to identify a plurality of features. In one embodiment, the features may be anything that may affect a health of the individual that can be quantified from the external data. For example, features may include demographic information such as sex, address, age group, and the like. The features may include health related information such as weight, height, cholesterol levels, blood counts, blood sugar level, and the like. The features may include lifestyle data from surveys such as how often an individual gets a physical exam, how often the individual goes to a doctor's office, how often the individual exercises, a type of diet, and the like.

At step 508, the method 500 divides each one of the plurality of features into one of six action classes. In one embodiment, a single feature may be placed into two or more of the action classes. In other words, each one of the plurality of features is not necessarily limited to a single action class. In one embodiment, the six action classes may include a clinical action class, a compliance action class, a demographics action class, an efficiency action class, a lifestyle action class and a readiness-to-change action class.

In one embodiment, from the plurality of features, one or more actionable features may also be identified based on domain knowledge accumulated from the training data and testing data that are compiled from the data collected from the external data sources. For example, over time certain features may be known to be actionable features.

In one embodiment, actionable features may be defined as features which an individual may control. For example, actionable features may include weight (e.g., the individual may diet to regulate his or her weight), smoking, drinking, blood sugar level (e.g., the individual may control his or her sugar intake), regular physicals, and the like. Some features may not be actionable, such as for example, genetic or hereditary dispositions such as having a fatty liver, high blood pressure, allergies to certain foods that may affect the individual's diet, a handicap that prevents the individual from taking regular visits to a doctor's office, and the like.

At step 510, the method 500 builds one or more models for each one of the six action classes. In one embodiment, each action class may have the same one or more models. In another embodiment, each action class may have different ones of the one or more models. In one embodiment, the one or more models may include a logistic regression model, a random forest model, and the like.

At step 512, the method 500 computes an overall HQI using the one or more models. For example, a HQI for each one of the six classes may be computed for each one of the models that are built. An aggregate HQI may be computed for each one of the six classes and each model. An overall HQI may be computed for each model using each one of the six classes. The overall HQI may then be computed by aggregating all of the aggregate HQIs and the overall HQIs for each model, for example as illustrated in FIG. 2 and described above.

In one embodiment, during the computation of the HQIs, one or more important features may be identified from the features in each one of the six classes. In one embodiment, the important features may be defined as those features that create a largest delta in the HQI when the feature is included or excluded from the HQI computation. In other words, the important features may be the features that have the largest effect on the computation of the HQI.

In one embodiment, a top k number of important features may be selected from each one of the six action classes. In other words, dithering is performed on the features from each one of the six action classes to obtain the top k number of important features.

At step 514, the method 500 identifies a health upside optimizing recommendation. In one embodiment, a health upside optimizing recommendation may then be based on one or more actionable important features selected from the actionable features and the important features. For example, the one or more actionable important features are features that are identified as being important and also identified as being actionable. In other words, even if a feature is important, but not actionable, the feature may not be helpful in being part of the health upside optimizing recommendation as the individual may not have any control over the feature and cannot improve his or her overall HQI based on the feature.

At step 516, the method 500 provides the overall HQI and the health upside optimizing recommendation. In one embodiment, the overall HQI and the health upside optimizing recommendation may be provided to a device of the individual via a GUI. In one embodiment, the overall HQI may be provided alongside an overall peer HQI to allow the individual to compare his or her overall health to her peer group.

In one embodiment, the peer score may be computed based on an average of a particular group that the individual belongs to. For example, the particular group may be a demographic group (e.g., age, region, and the like). In another embodiment, the particular group may be a group with a common ailment (e.g., diabetics, high blood pressure, and the like). The method 500 then proceeds to 518 where the method 500 ends.

As a result, the embodiments of the present disclosure transform general clinical data and non-clinical data to produce an overall health quality index that provides a holistic overview of an individual's health. The data is transformed from providing general disconnected data (e.g., clinical data and no-clinical data that are otherwise unrelated) into an overall HQI that provides a data driven objective overview of the individual's health based on a variety of different types of data. In other words, a new method is also provided that allows the transformation all of the different types of data that are collected into an objective score, i.e., the overall HQI.

Furthermore, the embodiments of the present disclosure improve the functioning of an application server or computer used for health analysis. For example, more accurate estimations of an individual's health may be performed by the computer (e.g., for pricing health insurance premiums, and the like). In other words, the technological art of estimating an individual's health is improved by providing a more accurate overview that is depicted by the overall HQI of the present disclosure.

It should be noted that although not explicitly specified, one or more steps, functions, or operations of the method 500 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 5 that recite a determining operation, or involve a decision, do not necessarily require that both branches of the determining operation be practiced. In other words, one of the branches of the determining operation can be deemed as an optional step.

FIG. 6 depicts a high-level block diagram of a general-purpose computer suitable for use in performing the functions described herein. As depicted in FIG. 6, the system 600 comprises one or more hardware processor elements 602 (e.g., a central processing unit (CPU), a microprocessor, or a multi-core processor), a memory 604, e.g., random access memory (RAM) and/or read only memory (ROM), a module 605 for calculating an overall health quality index (HQI) and providing a health upside optimizing recommendation, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for calculating an overall health quality index (HQI) and providing a health upside optimizing recommendation (e.g., a software program comprising computer-executable instructions) can be loaded into memory 604 and executed by hardware processor element 602 to implement the steps, functions or operations as discussed above in connection with the exemplary method 500. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for calculating an overall health quality index (HQI) and providing a health upside optimizing recommendation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for calculating an overall health quality index (HQI) and providing a health upside optimizing recommendation, comprising:
collecting, by a processor, data associated with an individual from an external data source;
filtering, by the processor, the data to identify a plurality of features;
dividing, by the processor, each one of the plurality of features into one or more of six action classes;
building, by the processor, one or more models for each one of the six action classes;
computing, by the processor, the overall HQI using the one or more models that are built for each one of the six action classes;
identifying, by the processor, the health upside optimizing recommendation based on one or more important actionable features selected from the plurality of features; and
providing, by the processor, the overall HQI and the health upside optimizing recommendation.

2. The method of claim 1, wherein the external data source comprises at least one of: a Center for Disease Control (CDC) database, a medical records database, a health insurance claims database, a prescription database, a lab results database, a clinical visits records database, a health plan enrollment application database or a survey database.

3. The method of claim 1, wherein the six action classes consist of a clinical action class, a compliance action class, a demographics action class, an efficiency action class, a lifestyle action class and a readiness-to-change action class.

4. The method of claim 1, wherein the computing further comprises:
computing, by the processor, a healthy quality index for each one of the six action classes using each one of the one or more models that are built; and
aggregating, by the processor, the health quality index for each one of the six action classes and the each one of the one or more models to compute the overall HQI.

5. The method of claim 1, wherein the one or more models comprise at least one of: a logistic regression model or a random forest model.

6. The method of claim 1, wherein the identifying further comprises:
selecting, by the processor, a top k features from the plurality of features in each one of the six action classes based on a significance of each one of the plurality of features;
selecting, by the processor, one or more features from the plurality of features that are actionable; and
selecting, by the processor, the one or more important actionable features based on one or more features of the top k features that are also one or more features that are actionable.

7. The method of claim 6, wherein the one or more features of the top k features that are also one or more features that are actionable are selected randomly.

8. The method of claim 1, wherein the providing further comprises providing one or more peer HQIs with the overall HQI of the individual.

9. The method of claim 1, wherein the providing further comprises providing the HQI of each one of the six action classes.

10. The method of claim 1, wherein the overall HQI and the health upside optimizing recommendation are provided via graphical user interface.

11. A non-transitory computer-readable medium storing a plurality of instructions which, when executed by a processor, cause the processor to perform operations for calculating an overall health quality index (HQI) and providing a health upside optimizing recommendation, the operations comprising:
collecting data associated with an individual from an external data source;
filtering the data to identify a plurality of features;
dividing each one of the plurality of features into one or more of six action classes;
building one or more models for each one of the six action classes;
computing the overall HQI using the one or more models that are built for each one of the six action classes;
identifying the health upside optimizing recommendation based on one or more important actionable features selected from the plurality of features; and
providing the overall HQI and the health upside optimizing recommendation.

12. The non-transitory computer-readable medium of claim 11, wherein the external data source comprises at least one of: a Center for Disease Control (CDC) database, a medical records database, a health insurance claims database, a prescription database, a lab results database, a clinical visits records database, a health plan enrollment application database or a survey database.

13. The non-transitory computer-readable medium of claim 11, wherein the six action classes consist of a clinical action class, a compliance action class, a demographics action class, an efficiency action class, a lifestyle action class and a readiness-to-change action class.

14. The non-transitory computer-readable medium of claim 11, wherein the computing further comprises:
computing a healthy quality index for each one of the six action classes using each one of the one or more models that are built; and
aggregating the health quality index for each one of the six action classes and the each one of the one or more models to compute the overall HQI.

15. The non-transitory computer-readable medium of claim 11, wherein the one or more models comprise at least one of: a logistic regression model or a random forest model.

16. The non-transitory computer-readable medium of claim 11, wherein the identifying further comprises:
selecting a top k features from the plurality of features in each one of the six action classes based on a significance of each one of the plurality of features;
selecting one or more features from the plurality of features that are actionable; and
selecting the one or more important actionable features based on one or more features of the top k features that are also one or more features that are actionable.

17. The non-transitory computer-readable medium of claim 16, wherein the one or more features of the top k features that are also one or more features that are actionable are selected randomly.

18. The non-transitory computer-readable medium of claim 11, wherein the providing further comprises providing one or more peer HQIs with the overall HQI of the individual.

19. The non-transitory computer-readable medium of claim 11, wherein the overall HQI and the health upside optimizing recommendation are provided via graphical user interface.

20. A method for calculating an overall health quality index (HQI) and providing a health upside optimizing recommendation, comprising:
collecting, by a processor, data associated with an individual from an external data source;
filtering, by the processor, the data to identify a plurality of features;
selecting, by the processor, a plurality of actionable features from the plurality of features based on a domain knowledge database;
dividing, by the processor, each one of the plurality of features into one or more of six action classes consisting of a clinical action class, a compliance action class, a demographics action class, an efficiency action class, a lifestyle action class and a readiness-to-change action class;
building, by the processor, a plurality of models for each one of the six action classes based on one or more of the plurality of features that are divided into the six action classes;
computing, by the processor, an HQI for each one of the six action classes using each one of the plurality of models that are built for each one of the six action classes;
aggregating, by the processor, the HQI for each one of the six action classes to compute the overall HQI;
selecting, by the processor, one or more important features from each one of the six action classes based on the one or more of the plurality of features in each of the six action classes that provide a greatest delta to the overall HQI;
identifying, by the processor, the health upside optimizing recommendation based on one or more important actionable features selected from the one or more important features that are also one or more of the plurality of actionable features; and
providing, by the processor, the overall HQI and the health upside optimizing recommendation to the individual via a graphical user interface.
